(19) United States
(12) Patent Application Publication
(10) Pub. No.: US 2006/0048394 A1
(43) Pub. Date: Mar. 9, 2006

(54) Methods and apparatus for a cutting device

(76) Inventors: Opher Yom-Tov, San Francisco, CA (US); Thomas Overthun, San Francisco, CA (US); David Webster, San Francisco, CA (US); Annetta M. Papadopoulos, Palo Alto, CA (US); James R. Yurchenco, Palo Alto, CA (US)

Correspondence Address: Daniel R. Pote;Snell & Wilmer L.L.P., One Arizona Center, 400 East Van Buren, Phoenix, AZ, 85004-2202, US

(21) Appl. No.: 10/936,056

(22) Filed: Sep. 8, 2004

(51) Int. Cl. B26B 13/00

(52) U.S. Cl. 30/194

(57) ABSTRACT

A set of kitchen shears are spring-assisted to provide efficient cutting action and, at the same time, to allow disassembly into two or more components to facilitate cleaning of the unit. The kitchen shears include: a first shears segment including a first handle rigidly coupled to a first blade, and a second shears segment including a second handle rigidly coupled to a second blade, wherein at least one edge of at least one of the first and second blades includes a sharpened edge; the first and second shears segments being removeably coupled about a pivot point such that the shears have an open state and a closed state, wherein the closed state corresponds to a user applying compressive force to the first and second handles, and wherein the open state corresponds to the absence of a compressive force to the first and second handles; and a spring apparatus mechanically coupled to the first and second handles to position said shears in said open state.

### FIELD OF THE INVENTION

The present invention generally relates to food preparation devices and, more particularly, to an improved shearing or cutting apparatus.

### BACKGROUND OF THE INVENTION

Kitchen scissors or shears are often used to cut through food items that are not conveniently severed using conventional knives. For example, kitchen shears provide a relatively controlled and safe method of cutting through such items as chicken bones and other hard-to-cut foodstuffs.

Currently known kitchen shears are undesirable in a number of respects. For example, many kitchen shears are configured and shaped like standard household scissors, allowing the user's hand to fit within loops, and requiring the user to apply outward force to open the scissors after cutting. In order to assist in opening the blades, some prior art kitchen shears provide a spring loaded mechanism. Such shears are often termed “spring-assisted” shears.

At the same time, conventional kitchen shears can be difficult to clean, as the hinge or pivot point of the shears is a relatively small gap that can be contaminated with foodstuffs, bacteria, etc. In order to address this problem, some prior art shears allow the two halves of the unit to be separated, therefore facilitating cleaning in a dishwasher or the like.

Despite the above, no currently known spring-assisted shears are capable of being separated into separate components for easy cleaning. This is due in part to the difficulty of designing shears in the context of conflicting goals, i.e., producing shears that are both spring loaded (thus forcing the two halves apart) and separatable (thus requiring the two halves to be held together).

Accordingly, there is a need for shearing and cutting devices which overcome these and other limitation of the prior art.

### SUMMARY OF THE INVENTION

In general, the present invention provides a novel set of kitchen shears that are spring-assisted to provide efficient cutting action and, at the same time, allow disassembly into two or more components to facilitate cleaning of the unit. In accordance with one embodiment of the present invention, the kitchen shears include: a first shears segment including a first handle rigidly coupled to a first blade, and a second shears segment including a second handle rigidly coupled to a second blade, wherein at least one edge of at least one of said first and second blades includes a sharpened edge; said first and second shears segments being removeably coupled about a pivot point such that said shears have an open state and a closed state, wherein said closed state corresponds to a user applying compressive force to said first and second handles, and wherein said open state corresponds to the absence of a compressive force to said first and second handles; and a spring apparatus mechanically coupled to said first and second handles to position said shears in said open state.

### BRIEF DESCRIPTION OF THE DRAWINGS

A more complete understanding of the present invention may be derived by referring to the detailed description when considered in connection with the Figures, where like reference numbers refer to similar elements throughout the Figures, and:

FIG. 1 is a side view of shears in accordance with one embodiment of the present invention;

FIG. 2 is an isometric view of the shears shown in FIG. 1;

FIG. 3 is an isometric view of one half of the detached shears;

FIG. 4 is an isometric view of the second half of the detached shears;

FIG. 5 is an exploded view of the detached half shown in FIG. 3; and

FIG. 6 is an exploded view of the detached half shown in FIG. 4.

### DETAILED DESCRIPTION

The following description is of exemplary embodiments of the invention only, and is not intended to limit the scope, applicability or configuration of the invention in any way. Rather, the following description is intended to provide a convenient illustration for implementing various embodiments of the invention. As will become apparent, various changes may be made in the function and arrangement of the elements described in these embodiments without departing from the scope of the invention.

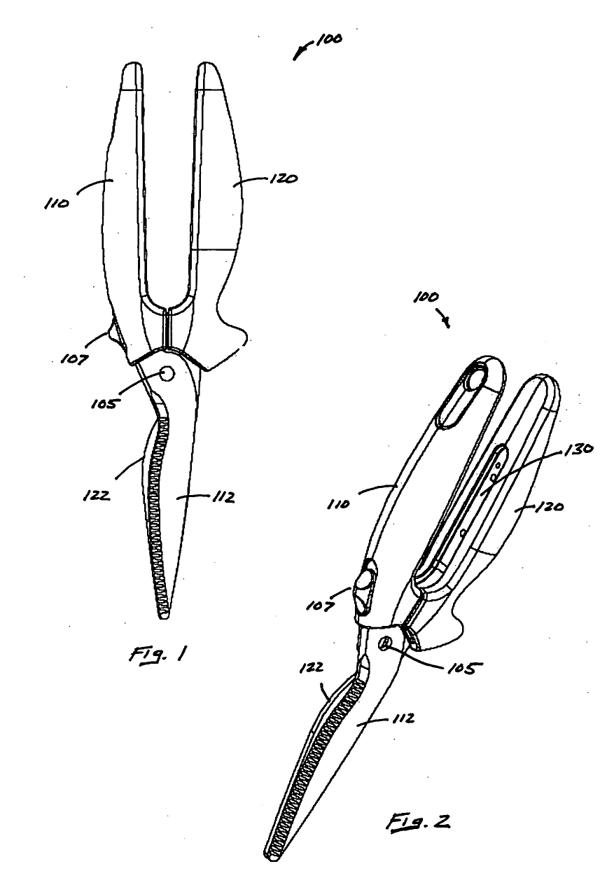

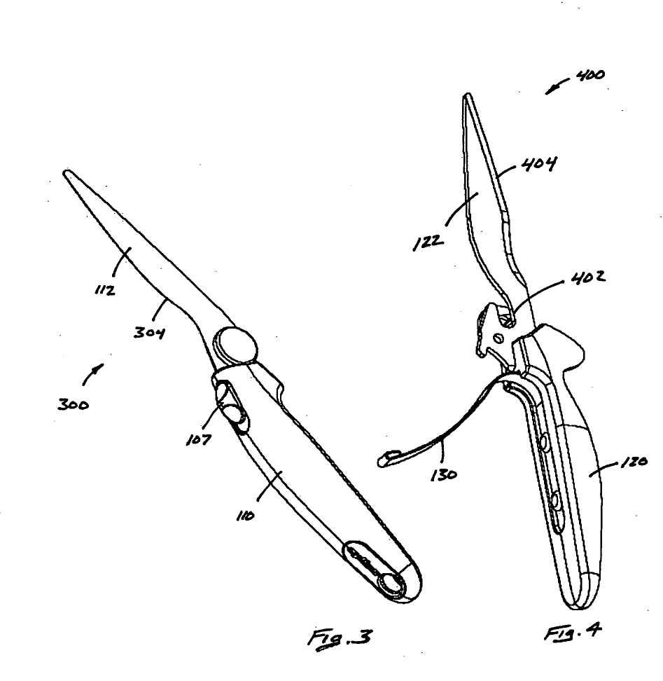

In general, the present invention provides a set of kitchen shears whose blades can be separated (e.g., for easy cleaning), while at the same time being spring-assisted and lockable. Referring to FIG. 1, a set of kitchen shears, scissors, or simply “shears” 100 in accordance with one embodiment of the present invention is shown. In this illustration, as well as in FIG. 2, the shears are shown in the closed or locked state. As such, shears 100 comprise a first grip or handle 110 coupled to a first blade 112, and a second grip or handle 120 coupled to a second blade. The two blades 112 and 122 are rotatably coupled around a pivot 105 such that shears 100 exhibit scissor-like movement during operation. Shears 100 may also include a lock actuator 107, discussed in further detail below.

As shown in FIG. 2, shears 100 also preferably include a spring 130 coupled to at least one of the handles (in this embodiment, handle 120), for forcing handles 110 and 120 apart in the open or unlocked state. Thus, the shears are spring assisted, adding to user comfort and efficiency during cutting.

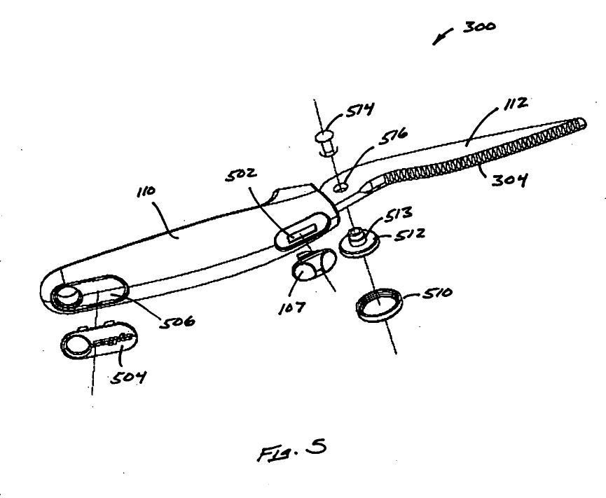

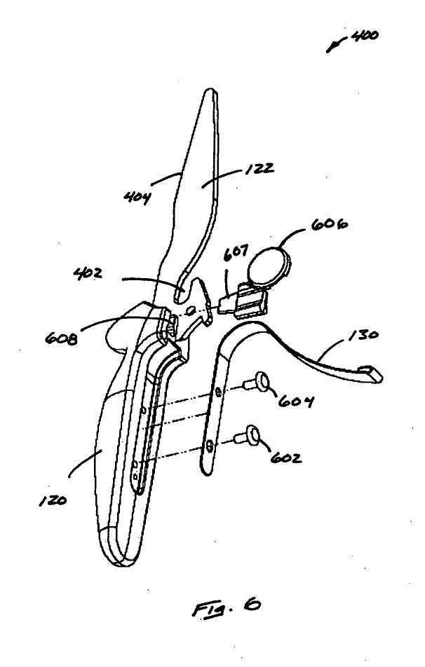

FIGS. 3 and 4 show one embodiment of the present invention wherein the two halves of the shears have been separated. As shown, a first shears segment 300 includes blade 112 (having a cutting edge 304), coupled to handle 110, which optionally includes a lock actuator 107. Similarly, as shown in FIG. 4, the second shears segment 400 comprises blade 122 having a cutting edge 404 and coupled to handle 120. In the separated state, spring 130 extends outward such that it is under compression (or bending) during normal operation. Blade 122 includes a cutout or pivot opening 402. Pivot opening 402 is configured to accept the outer diameter of a pivot component extending from the pivot point of segment 300 (not shown in FIG. 3), such that the two segments may be separated by the user using moderate force. During normal operation, the forces applied to handles 120 and 110 do not result in separation of the two segments, as detailed below.

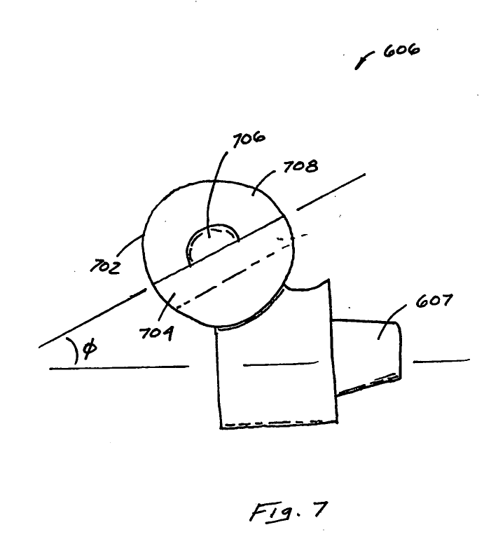

FIG. 5 shows an exploded overview of first segment 300 of the shears. In this embodiment, an optional insert 504 (e.g., bearing brand indicia, a color code, or the like), is configured to seat within an insert region 506 provided within handle 110. In this embodiment, insert region 506 and insert 504 include a through-hold, allowing the shears to be hung for easy storage.

Lock actuator 107 fits within a lock opening 502 and has a suitable locking mechanism configured to secure first segment 300 and first segment 400 in a closed position. In the illustrated embodiment, lock actuator may be moved back and forth by the user to select the locked or unlocked state. Such locking mechanisms are generally known, and therefore will not be discussed in detail herein.

Blade 112 includes an opening 516 through which a rivet or projection 514 may be secured to pivot component 512 and cap 510. The outer diameter 513 of pivot component is exposed and is configured to fit within the pivot opening 402 shown in FIG. 4.

In the illustrated embodiment, cutting edge 304 of blade 112 is serrated. It will be appreciated that this is optional, and that any suitable combination of serrated or straight blades may be used in connection with the present invention. Similarly, blades 112 and 122 may be manufactured from any suitable material, including various metals, plastics, and ceramics. In the preferred embodiment, blades 122 and 112 are stainless steel.

FIG. 6 shows an exploded view of first segment 400. In this embodiment, spring 130 is attached to the inner surface of handle 120 via two securing devices 602 and 604. It will be understood that any conventional spring unit may be used, and that spring 130 may be secured to handle 120 in any suitable location using any suitable method, including various fasteners, adhesives, screws, compressive fits, etc.

As mentioned above, blade 404 includes a pivot cutout 402 configured to receive the outer diameter of a pivot component attached to the second segment. In the illustrated embodiment, cutout 402 is generally oval-shaped, and has a major axis generally parallel with handle 120. That is, the second segment is removed from segment 400 by spreading the respective handles past their normal operating point such that the pivot component translates upward and out of cutout 402. In this way, the two segments remain connected during the standard scissor action, but can be separated for easy cleaning.

In this embodiment, a detent unit 606 is included to assist in keeping the two segments attached during normal operating conditions. In the preferred embodiment, the detent unit 606 includes a tab 607 that fits within a corresponding opening 608 within handle 120. It will be appreciated that detent unit may be part of (i.e., integral with) handle 120, or may have various other configurations.

More particularly, referring to FIG. 7, an exemplary detent unit 606 includes a circular region 702 which makes contact with and compressively engages a portion of component 514 (shown in FIG. 5). In particular, circular region includes a high-thickness area 708, which is generally a semi-circular ring shape, and which includes a central indent region 706. Region 706 has a thickness that may vary (e.g., may be hemispherical), but which is less than the thickness of region 708. Indent region 706 is configured to accept the end of pivot component 514 shown in FIG. 5, which itself may have a generally hemispherical shape. A lower-thickness region 704 allows pivot component 514 to move laterally after being unseated from central indent 706.

To facilitate separation of the shears segments, while at the same time preventing separation during normal operation, indent region 704 is suitably angled with respect to the handles of the shears (and thus tab 607). In the preferred embodiment, the angle between tab axis 607 and the axis of region 704 (θ) is between approximately 20 and 50 degrees, preferably between about 30 degrees and 45 degrees, and most preferably about 40 degrees. It will be appreciated, however, that the present invention is not so limited, and encompasses any suitable combination of detent components and geometries.

Other advantages and structural details of the invention will be apparent from the attached figures, which will be well understood by those skilled in the art. The present invention has been described above with to a particular exemplary embodiment. However, many changes, combinations and modifications may be made to the exemplary embodiments without departing from the scope of the present claims.

1. A set of kitchen shears comprising:
a first shears segment including a first handle rigidly coupled to a first blade, and a second shears segment including a second handle rigidly coupled to a second blade, wherein at least one edge of at least one of said first and second blades includes a sharpened edge;
said first and second shears segments being removeably coupled about a pivot point such that said shears have an open state and a closed state, wherein said closed state corresponds to a user applying compressive force to said first and second handles, and wherein said open state corresponds to the absence of a compressive force to said first and second handles;
a spring apparatus mechanically coupled to said first and second handles to position said shears in said open state.

2. The shears of claim 1, wherein said pivot point includes a detent unit configured to removeably secure said first and second segments in said first state and said second state.

3. The shears of claim 2, wherein said detent unit is fixed to said first segment and includes a central indentation configured to accept a pivot component fixed to said second segment.

4. The shears of claim 1, wherein said second segment includes a pivot opening configured to accept a pivot component fixed to said first segment.

5. The shears of claim 1, further including a locking apparatus configured to temporarily lock said first and second segments together in said closed state.
